(19) United States
(12) Patent Application Publication
(10) Pub. No.: US 2025/0119715 A1
(43) Pub. Date: Apr. 10, 2025

(54) Consumer-Controllable ML Model Provisioning in a Wireless Communication Network

(71) Applicant: Telefonaktiebolaget LM Ericsson (publ), Stockholm (SE)

(72) Inventors: Jing Yue, Danderyd (SE); Zhang Fu, Stockholm (SE); Ulf Mattsson, Kungsbacka (SE); Mirko D'Angelo, Göteborg (SE); Maria Belen Pancorbo Marcos, Madrid (ES)

(21) Appl. No.: 18/727,269

(22) PCT Filed: Jul. 21, 2022
(86) PCT No.: PCT/IB2022/056753

§ 371 Date: Jul. 8, 2024

Related U.S. Application Data
(60) Provisional application No. 63/299,145, filed on Jan. 13, 2022.

(51) Int. Cl. H04W 4/50; H04L 41/16; H04L 67/51

(52) U.S. Cl. CPC H04W 4/50; H04L 41/16; H04L 67/51

(57) ABSTRACT

A process is defined for consumer-controllable ML model provisioning and training in a wireless communication network. The process comprises two procedures, which respectively correspond to the two phases of an ML model provisioning process in, e.g., 5GC, i.e., the preparation/provisioning phase and the training execution phase. For the preparation/provisioning phase, new parameters are added to the request from the ML model consumer to the ML model generator (e.g., NWDAF), so that the latter can conduct the ML model provisioning according to the consumer requirements. For the training execution phase, interactions between the ML model consumer and generator(s) are considered, and the corresponding procedure for a consumer controlling the ML model training execution phase is defined.

### FIELD OF DISCLOSURE

The present disclosure relates generally to wireless communication networks, and in particular to methods for consumer control of Machine Learning model provisioning and training.

### BACKGROUND

Wireless communication networks, including network nodes and radio network devices such as cellphones and smartphones, are ubiquitous in many parts of the world. These networks continue to grow in capacity and sophistication. To accommodate both more users and a wider range of types of devices that may benefit from wireless communications, the technical standards governing the operation of wireless communication networks continue to evolve. The fourth generation of network standards (4G, also known as Long Term Evolution, or LTE) has been deployed, the fifth generation (5G, also known as New Radio, or NR) is in development or the early stages of deployment, and the sixth generation (6G) is being planned.

Release 15 (Rel-15) of the Third Generation Partnership Project (3GPP) standard for 5G networks introduced a new Network Function (NF) called the Network Data Analytics Function (NWDAF), the basic functionality of which is specified in Release 16 (Rel-16). Development of more advanced uses cases is ongoing for Release 17 (Rel-17). Generally, the NWDAF performs two types of analytics processing: statistical analytics and predictive analytics. Statistical analytics provide information about what is currently happening in the network (or has happened in the past). Predictive analytics provides information about what is likely to happen in the future, based on current and historical trends. In both cases, advanced NWDAFs rely on Machine Learning (ML) models to process large volumes of data, to produce statistical and/or predictive analytics. As known in the art, ML is an application of Artificial Intelligence (Al) that refers to computer systems having the ability to automatically learn and adapt without following explicit instructions, by using algorithms and statistical models to analyze and draw inferences from patterns in data—usually very voluminous datasets.

An Analytics Logical Function (AnLF) is a component of a NWDAF that performs data analytics and exposes the analytics service to other NFs. A Model Training Logical Function (MTLF) is a component that trains ML models for use in providing the analytics service and exposes the training service to other NFs. A NWDAF can include an AnLF, a MTLF, or both. A NWDAF with a MTLF can train the machine learning model used in providing an analytics service by another NWDAF with an AnLF.

One development in the field of ML modeling is distributed machine learning (DML). In DML, the ML model training process is carried out using distributed resources, which significantly accelerate the training speed and reduce the training time. See, e.g., J. Liu, et al., “From distributed machine learning to federated learning: A survey.” arXiv preprint arXiv:2104.14362v2, May 10, 2021, the disclosure of which is incorporated herein by reference in its entirety. In the wireless network context, DML can relieve congestion by sending a limited amount of data to central servers for an ML training task, meanwhile protecting sensitive information, and preserving data privacy of the devices in the network.

The Parameter Server (PS) framework is a key underlying architecture of centrally assisted DML. FIG. 1 depicts a general model of the PS framework in DML. There are two types of nodes in a PS framework, i.e., server and client (or worker). There may be one or multiple servers. The client nodes are partitioned into groups. The servers maintain all or part of ML model parameters, and aggregate the weights from each client group. The client nodes conduct the initial steps of a learning algorithm. Unlike a centralized approach, each client uses a synchronized global gradient from the server nodes to carry out ML training operations, such as back propagation and weight refreshments. The clients only share the ML model parameters with the servers, and never communicate with each other. The PS architecture has been broadly applied to decentralize ML tasks on wired platforms.

Academic studies on DML have been heavily focused on Federated Learning (FL), which is a popular architecture of DML for decentralized generation of generic ML models, its related technologies and protocols, and several application scenarios. See, e.g., S. Hu, et al., “Distributed machine learning for wireless communication networks: Techniques, architectures, and applications.” IEEE Communications Surveys & Tutorials, vol. 23, No. 3, Third Quarter 2021, and Q. Li, et al., “A survey of federated learning system: Vision, hype and reality for data privacy and protection.” arXiv preprint arXiv:1907.09693v6, Jul. 1, 2021, the disclosures of both of which are incorporated herein by reference in their entireties.

FL enables the collaborative training of ML models among different organizations under the privacy restrictions. The main idea of FL is to build ML models based on data sets that are distributed across multiple devices, while preventing data leakage. See, e.g., Q. Yang, et al., “Federated machine learning: Concept and applications.” arXiv preprint arXiv:1902.04885v1, Feb. 13, 2019, the disclosure of which is incorporated herein by reference in its entirety. In an FL system, multiple parties collaboratively train ML models without exchanging their raw data. The output of the system is an ML model for each party (which can be same or different).

There are three major components in an FL system: parties (e.g., clients), manager (e.g., server), and communication-computation framework to train the ML model. The parties are the data owners and the beneficiaries of FL. The manager is typically a powerful central server, or one of the organizations, who dominates the FL process under different settings. Computation occurs at both the parties and the manager, and communication occurs between the parties and the manager. Usually, the aim of the computation is for the ML model training, and the aim of the communication is for exchanging the ML model parameters.

A widely used FL framework is Federated Averaging (FedAvg). See, e.g., H. McMahan, et al., “Communication-efficient learning of deep networks from decentralized data.” arXiv preprint arXiv:1602.05629, 2016, the disclosure of which is incorporated herein by reference in its entirety. FIG. 2 depicts the FedAvg model. Generally, in each iteration, the following processes occur:
1. The server first sends the current global model to the selected parties;
2. The selected parties update the global model using their local data;
3. The updated models are then sent back to the server; and
4. The server averages all the received local models, to generate a new global model.

This process repeats until reaching a specified number of iterations. The global ML model of the server is the final output.

3GPP has considered this research, and proposed a standard for “Federated Learning among Multiple NWDAF Instances” in 3GPP Technical Report (TR) 23.700-91 v17.0.0, § 6.24, et. seq. In particular, this TR addresses previously identified key issues: Key Issue #2, “Multiple NWDAF instances,” and Key Issue #19, “Trained data model sharing between multiple NWDAF instances.” The above-cited 3GPP TR 23.700-91 is reproduced below. Note that the referenced FIG. 6.24.1.1-1 is reproduced as FIG. 3 in this disclosure, and FIG. 6.24.1.1-2 is reproduced as FIG. 4.

### 6.24 Solution #24: Federated Learning among Multiple NWDAF Instances

### 6.24.1 Description

This is a solution for the Key Issue #2: Multiple NWDAF instances and Key Issue #19: Trained data model sharing between multiple NWDAF instances.

### 6.24.1.1 General

As shown in FIG. 6.24.1.1-1, multiple NWDAF will be deployed in a big PLMN, so maybe it is difficult for NWDAF to centralize all the raw data that are distributed in different Areas. However, it is desired or reasonable for the NWDAF distributed in an Area to share its model or data analytics with others NWDAFs.
Federated Learning (also called Federated Machine Learning) could be a possible solution to handle the issues such as data privacy and security, model training efficiency, and so on, in which there is no need for raw data transferring (e.g. centralized into single NWDAF) but only need for model sharing. For example, with multiple level NWDAF architecture, NWDAFs may be co-located with an 5GC NF (e.g. UPF, SMF), and the raw data cannot be exposed due to privacy concerns and performance reasons. In such case, the federated learning will be a good way to let a Server NWDAF coordinate with multiple localized NWDAFs to complete a machine learning.
The main idea of Federated Learning is to build machine-learning models based on data sets that are distributed in different network functions. A Client NWDAF (e.g. deployed in a domain or network function) locally trains the local ML model with its own data and share it to the server NWDAF. With local ML models from different Client NWDAFs, the Server NWDAF could aggregate them into a global or optimal ML model or ML model parameters and send them back to the Client NWDAFs for inference.
This solution tries to involve the idea of Federated Learning into the NWDAF-based architecture, which aims to investigate the following aspects:
Registration and discovery of multiple NWDAF instances that support Federated Learning;
How to share the ML models or ML model parameters during the Federated Learning training procedure among multiple NWDAF instances.
   1-3. Client NWDAF registers its NF profile (Client NWDAF Type (see TS 23.502 [3] clause 5.2.7.2.2), Address of Client NWDAF, Support of Federated Learning capability information, Analytics ID(s)) into NRF.
   4-6. Server NWDAF discovers one or multiple Client NWDAF instances which could be used for Federated Learning via the NRF to get IP addresses of Client NWDAF instances by invoking the Nnrf_NFDiscovery_Request (Analytics ID, Support of Federated Learning capability information) service operation.
   It is assumed an Analytics Id is preconfigured for a type of Federated Learning. Thus, the NRF can realize the Server NWDAF is requesting to perform federated learning based on the pre-configuration. And the NRF responds to the central NWDAF the IP address of multiple NWDAF instances which support the Analytics Id.
   NOTE 1: The analytic ID(s) supporting Federated Learning can be configured by operator.
   7a: Each client NWDAF communicates licensing conditions for its data and training infrastructure to participate in the federated learning task. These conditions can be based on policies set-up based on how sensitive the data is, how much compute is expected to be needed to perform local training, who will get the use the trained model, etc.
   7b: Based on the response from NRF, Server NWDAF selects which NWDAF clients will participate based on its desired license model.
   7c. Server NWDAF sends a request to the selected Client NWDAFs that participate in the Federated learning according to steps 7a and 7b including some parameters (such as initial ML model, data type list, maximum response time window, etc.) to help the local model training for Federated Learning.
   8. Each Client NWDAF collects its local data by using the current mechanism in clause 6.2, TS 23.288 [5].
   9. During Federated Learning training procedure, each Client NWDAF further trains the retrieved ML model from the server NWDAF based on its own data, and reports the results of ML model training to the Server NWDAF, e.g. the gradiente.
   NOTE 2: Server NWDAF interacts with Client NWDAF to deliver and update the ML model, and how to transfer the ML model and local ML model training results are up to the conclusion of KI #19.
   10. The Server NWDAF aggregates all the local ML model training results retrieved at step 9 such as the gradient to update the global ML model.
   11. The Server NWDAF sends the aggregated ML model information (updated ML model) to each Client NWDAF for next ground model training.
   12. Each Client NWDAF updates its own ML model based on the aggregated model information (updated ML model) distributed by the Server NWDAF at step 11.
   NOTE 3: The steps 8-12 should be repeated until the training termination condition (e.g. maximum number of iterations, or the result of loss function is lower than a threshold) is reached. After the training procedure is finished, the globally optimal ML model or ML model parameters could be distributed to the Client NWDAFs for the inference.

3GPP Technical Standard (TS) 23.288 v17.2.0 § 6.1 et seq. specifies analytics service provided by NWDAFs exposure to NWDAF service consumer. This TS is reproduced below. Note that the referenced FIG. 6.1.1.1-1 is reproduced as FIG. 5 in this disclosure.

### 6.1 Procedures for Analytics Exposure

### 6.1.1 Analytics Subscribe/Unsubscribe

### 6.1.1.1 Analytics Subscribe/Unsubscribe by NWDAF Service Consumer

This procedure is used by any NWDAF service consumer (e.g. including NFs/OAM) to subscribe/unsubscribe at NWDAF to be notified on analytics information, using Nnwdaf_AnalyticsSubscription service defined in clause 7.2. This service is also used by an NWDAF service consumer to modify existing analytics subscription(s). Any entity can consume this service as defined in clause 7.2.
1. The NWDAF service consumer subscribes to or cancels subscription to analytics information by invoking the Nnwdaf_AnalyticsSubscription_Subscribe/Nnwdaf_AnalyticsSubscription_Unsubscribe service operation. The parameters that can be provided by the NWDAF service consumer are listed in clause 6.1.3.
When a subscription to analytics information is received, the NWDAF determines whether triggering new data collection is needed.
If the service invocation is for a subscription modification, the NF service consumer includes an identifier (Subscription Correlation ID) to be modified in the invocation of Nnwdaf_AnalyticsSubscription_Subscribe.
   2. If NWDAF service consumer is subscribed to analytics information, the NWDAF notifies the NWDAF service consumer with the analytics information by invoking Nnwdaf_AnalyticsSubscription_Notify service operation, based on the request from the NWDAF service consumer, e.g. Analytics Reporting Parameters. Termination Request. If the NWDAF provides a Termination Request, then the consumer cancels subscription to analytics information by invoking the Nnwdaf_AnalyticsSubscription_Unsubscribe service operation.

3GPP TS 23.288 v17.2.0 § 6.2A et seq. specifies ML model provisioning from NWDAF (containing MTLF) to NWDAF service consumer. This TS is reproduced below. Note that the referenced FIG. 6.2A.1-1 is reproduced as FIG. 6 in this disclosure.

### 6.2A Procedure for ML Model Provisioning

### 6.2A.0 General

This clause presents the procedure for the ML Model provisioning.
In this Release of the specification an NWDAF containing AnLF is locally configured with (a set of) NWDAF (MTLF) ID(s) and the Analytics ID(s) supported by each NWDAF containing MTLF to retrieve trained ML models. An NWDAF containing AnLF may use NWDAF discovery for NWDAF (MTLF) within the set of configured NWDAF (MTLF) ID(s), if necessary. An NWDAF containing MTLF may determine that further training for an existing ML model is needed when it receives the ML model subscription or the ML model request.
NOTE: ML Model provisioning/sharing between multiple NWDAF (MTLF)(s) is not specified in this Release of the specification.

### 6.2A.1 ML Model Subscribe/Unsubscribe

The procedure in FIG. 6.2A.1-1 is used by an NWDAF service consumer, i.e. an NWDAF (AnLF) to subscribe/unsubscribe at another NWDAF, i.e. an NWDAF containing MTLF, to be notified when ML model information on the related Analytics becomes available, using Nnwdaf_MLModelProvision services as defined in clause 7.5. The ML model information is used by an NWDAF containing AnLF to derive analytics. The service is also used by an NWDAF to modify existing ML Model Subscription(s). An NWDAF can be at the same time a consumer of this service provided by other NWDAF(s) and a provider of this service to other NWDAF(s).
1. The NWDAF service consumer (i.e. an NWDAF (AnLF)) subscribes to, modifies, or cancels subscription for a (set of) trained ML Model(s) associated with a (set of) Analytics ID(s) by invoking the Nnwdaf_MLModelProvision_Subscribe/Nnwdaf_MLModelProvision_Unsubscribe service operation. The parameters that can be provided by the NWDAF service consumer are listed in clause 6.2A.2.
When a subscription for a trained ML model associated with an Analytics ID is received, the NWDAF containing MTLF may:
   determine whether an existing trained ML Model can be used for the subscription; or
   determine whether triggering further training for an existing trained ML models is needed for the subscription.
If the NWDAF containing MTLF determines that further training is needed, this NWDAF may initiate data collection from NFs, (e.g. AMF/DCCF/ADRF), UE Application (via AF) or OAM as described in clause 6.2, to generate the ML model.
If the service invocation is for a subscription modification or subscription cancelation, the NWDAF service consumer includes an identifier (Subscription Correlation ID) to be modified in the invocation of Nnwdaf_MLModelProvision_Subscribe.
   2. If the NWDAF service consumer subscribes to a (set of) trained ML model(s) associated to a (set of) Analytics ID(s), the NWDAF containing MTLF notifies the NWDAF service consumer with the trained ML model information (containing a (set of) file address of the trained ML model) by invoking Nnwdaf_MLModelProvision_Notify service operation. The content of trained ML model information that can be provided by the NWDAF containing MTLF is specified in clause 6.2A.2.
The NWDAF containing MTLF also invokes the Nnwdaf_MLModelProvision_Notify service operation to notify an available re-trained ML model when the NWDAF containing MTLF determines that the previously provided trained ML Model required re-training at step 1.
When the step 1 is for a subscription modification (i.e., including Subscription Correlation ID), the NWDAF containing MTLF may provide either a new trained ML model different to the previously provided one, or re-trained ML model by invoking Nnwdaf_MLModelProvision_Notify service operation.

### 6.2A.2 Contents of ML Model Provisioning

The consumers of the ML model provisioning services (i.e. an AnLF of NWDAF) as described in clause 7.5 and clause 7.6 may provide the input parameters as listed below:
Information of the analytics for which the requested ML model is to be used, including:
   A list of Analytics ID(s): identifies the analytics for which the ML model is used.
   [OPTIONAL] ML model Filter Information: enables to select which ML model for the analytics is requested, e.g. S-NSSAI, Area of Interest. Parameter types in the ML Model filter information are the same as parameter types in the Analytics Filter Information which are defined in procedures.
   [OPTIONAL] Target of Analytics Reporting: indicates the object(s) for which ML model for the analytics is requested, entities such as specific UEs, a group of UE(s) or any UE (i.e. all UEs).
   [OPTIONAL] ML Model target period: indicates time interval [start, end] for which ML model for the Analytics is requested. The time interval is expressed with actual start time and actual end time (e.g. via UTC time).
   A Notification Target Address (+Notification Correlation ID) as defined in TS 23.502 [3] clause 4.15.1, allowing to correlate notifications received from the ML model provider NWDAF with this subscription.
      The ML model provider NWDAF (i.e. an MTLF of NWDAF) provides to the consumer of the ML model provisioning service operations as described in clause 7.5 and 7.6, the output information as listed below:
(Only for Nnwdaf_MLModelProvision_Notify) The Notification Correlation Information.
ML model information, which includes the ML model file address (e.g. URL or FQDN) for the Analytics ID(s).
[OPTIONAL] Validity period: indicates time period when the provided ML model information applies.
[OPTIONAL] Spatial validity: indicates Area where the provided ML model information applies.
   NOTE: Spatial validity and Validity period are determined by MTLF internal logic and it is a subset of Aol if provided in ML model Filter information and of ML Model target period, respectively.

In the solution given in TR 23.700-91 for FL among multiple NWDAF instances (i.e., Solution #24), the FL processes cannot be controlled by the consumer. Furthermore, generally the consumer cannot really control the model provisioning process or the training/learning processes. For example, the consumer has no idea if the model is trained online or offline, the type of data used, which training types are used (e.g., FL, reinforcement learning, etc.). However, in many practical applications, consumers require control of the processes of model provisioning in 5GC. For example, the Mobile Network Operator (MNO) may want to train a global model via the NWDAFs in different regions using DML/FL; in this case, the MNO is responsible for providing the instructions of model training and controlling the process of training. In addition, interaction between consumer and NWDAF during training/learning processes is necessary for NWDAF to make adjustments according to changes in requirements from the consumer. The current solution provided in TR 23.700-91 cannot support such use cases.

The Background section of this document is provided to place aspects of the present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later.

According to one or more aspects described and claimed herein, a process is provided for consumer-controllable ML model provisioning processes in 5GC. The process comprises two procedures, which respectively correspond to the two phases of an ML model provisioning process in 5GC, i.e., the preparation phase and the training execution phase. For the preparation phase, new parameters are added to the request from the consumer to the NWDAF, so that the NWDAF can conduct the ML model provisioning according to the consumer requirements. For the training execution phase, interactions between the consumer and NWDAF(s) are considered, and the corresponding procedure for a consumer controlling the ML model training execution phase is given.

One aspect relates to a method of controlling the provision of a Machine Learning (ML) model, by a consumer of the ML model, in a wireless communication network. A data analytics network function capable of providing the ML model and that supports consumer control of the ML model provisioning is selected. A service request related to an ML model is transmitted to the selected data analytics network function, wherein the request includes parameters specifying the provisioning of the ML model. A response to the request is received from the selected data analytics network function, the response including information about the requested service related to an ML model.

Another aspect relates to an ML model consumer apparatus operative in or connected to a wireless communication network. The consumer apparatus includes communication circuitry, and processing circuitry operatively connected to the communication circuitry. The processing circuitry is configured to transmit, to a selected data analytics network function capable of providing the ML model and that supports consumer control of the ML model provisioning, a service request related to an ML model, wherein the request includes parameters specifying the provisioning of the ML model; and receive from the selected data analytics network function a response to the request, the response including information about the requested service related to an ML model.

Yet another aspect relates to a method, by a data analytics network function operative in a wireless communication network, of providing a Machine Learning (ML) model according to specifications of a consumer of the ML model. A service request related to provisioning of an ML model is received from an ML model consumer, the request including parameters specifying the provisioning of the ML model. A time required to provide the requested service is determined. The determined time is transmitted to the ML model consumer.

Still another aspect relates to a network node implementing a data analytics network function in a wireless communication network. The network node includes communication circuitry and processing circuitry operatively connected to the communication circuitry. The processing circuitry is configured to receive, from an ML model consumer, a service request related to provisioning of an ML model, the request including parameters specifying the provisioning of the ML model; determine a time required to provide the requested service; and transmit, to the ML model consumer, the determined time.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a diagram of prior art Distributed Model Learning (DML).

FIG. 2 is a diagram of a prior art Federated Averaging architecture of DML.

FIG. 3 is a block diagram of prior art Federated Learning (FL) in 5GC.

FIG. 4 is a signaling diagram of prior art FL in 5GC.

FIG. 5 is a signaling diagram of prior art analytics subscription to a NWDAF by a consumer.

FIG. 6 is a signaling diagram of prior art ML model request by a consumer to a NWDAF in 5GC.

FIG. 7 is a signaling diagram of ML model consumer triggering and control of ML model provisioning.

FIG. 8 is a signaling diagram of consumer control of ML training execution.

FIG. 9 is a flow diagram of a method of controlling the provision of a ML model, by a consumer of the ML model, in a wireless communication network.

FIG. 10 is a flow diagram of a method by a data analytics network function operative in a wireless communication network, of providing a ML model according to specifications of a consumer of the ML model.

FIG. 11 is hardware block diagram of an apparatus.

FIG. 12 is a functional block diagram of an ML model consumer apparatus.

FIG. 13 is a functional block diagram of network node implementing a data analytics network function.

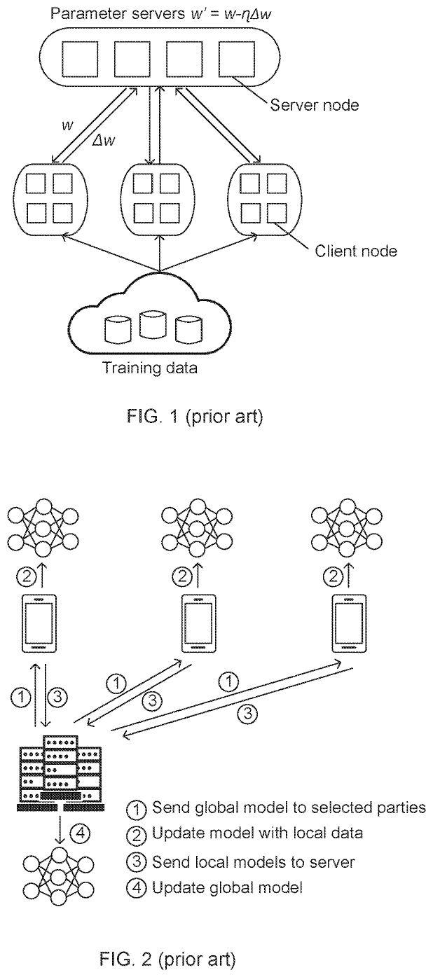

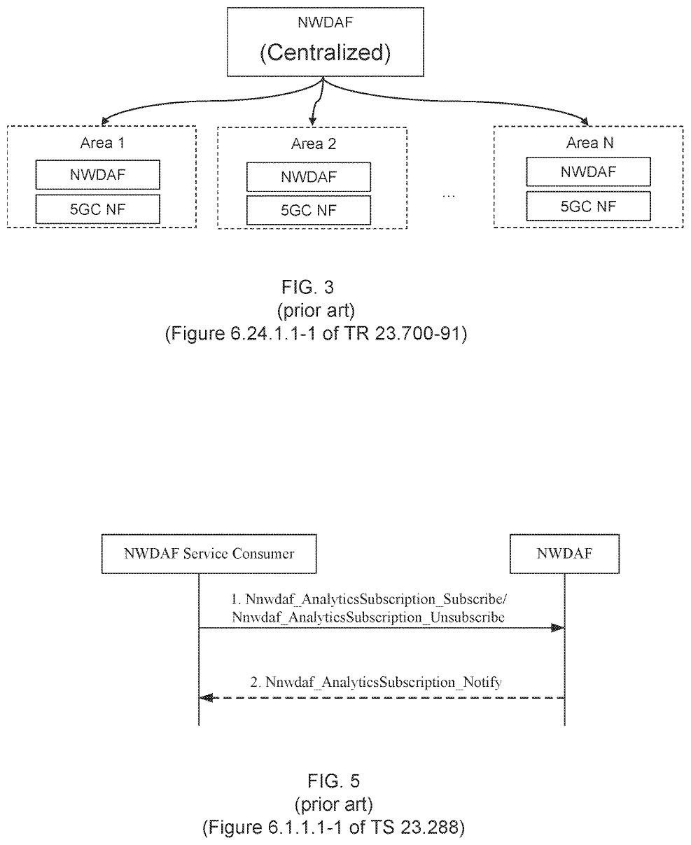

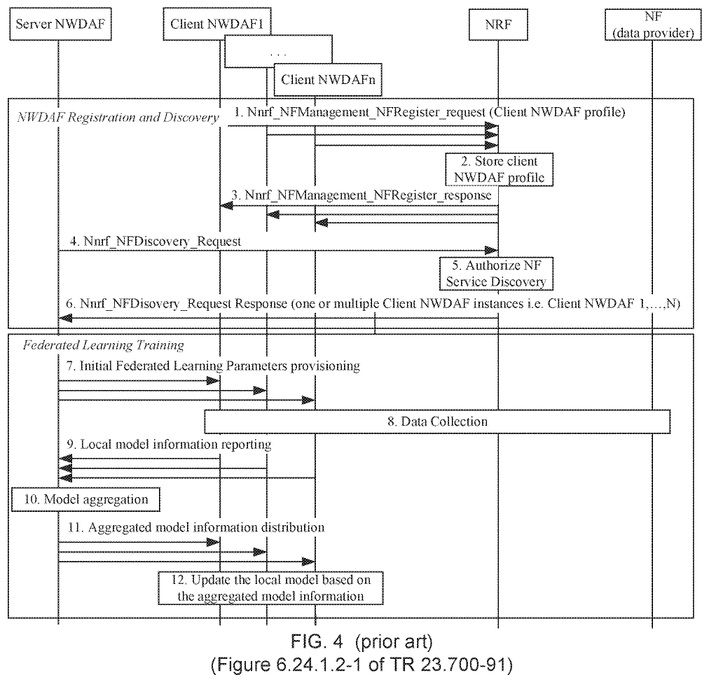

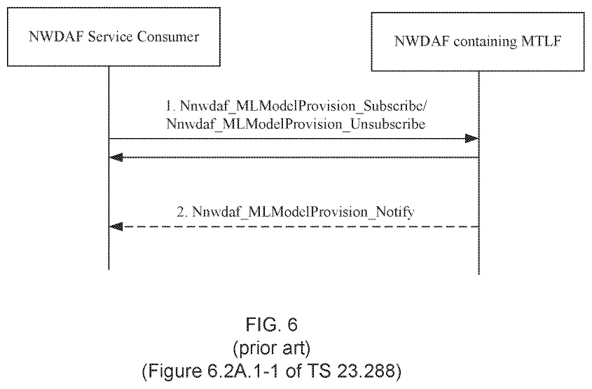

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

### Procedure for Consumer Trigger and Control of ML Model Provisioning

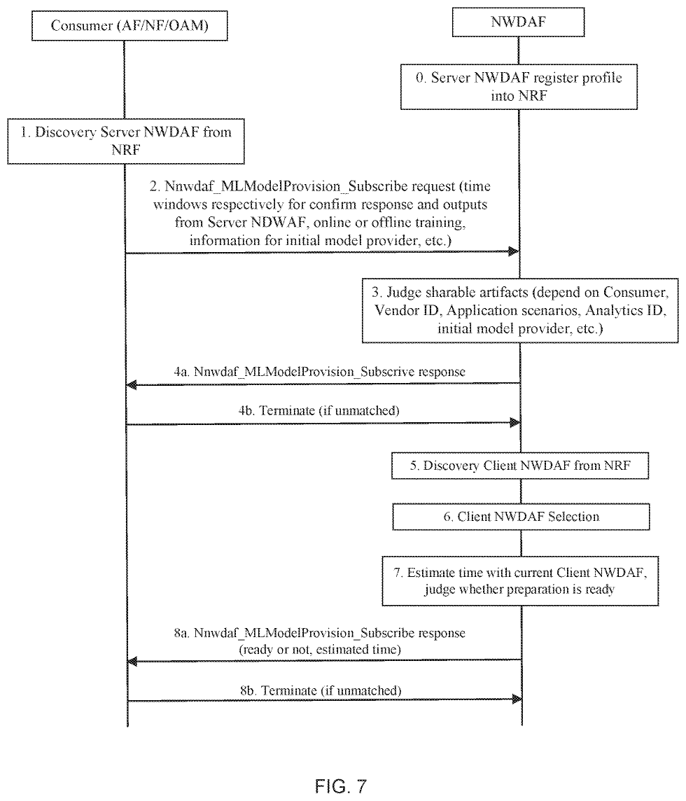

In practice in a wireless communication network, there could be many types of triggers that cause the NWDAF(s) to conduct DML/FL. As a representative and non-limiting example, a consumer-controlled process is explained with reference to a consumer, such as an Application Function (AF), Network Function (NF), or Operation, Administration, and Management (OAM) entity, triggering DML/FL via ML Model Providing request. In this case, the consumer (AF/NF/OAM) is aware that the ML model is produced via DML/FL, it may also provide an ML model architecture, as well as other instructions, to the NWDAF. Procedures for the consumer (AF/NF/OAM) triggering and controlling the preparation phase of ML model provisioning in 5GC is described, with respect to the signal diagram of FIG. 7.

At step 0 (e.g., at some time prior to the actual procedure), the NWDAF registers a profile into a registry, e.g., an NF Repository Function (NRF). In addition to other NRF registration elements of the NWDAF profile, the following elements are also provided by the NWDAF when registering its profile into NRF:
Capability of supporting consumer control, e.g., start, modify, restart, and terminate ML model training process according to the interactions with the consumer (AF/NF/OAM)
List of supported learning architectures, e.g., DML and/or FL framework, etc.
Capability to output intermediate results
Capability of running initial ML model provided by the consumer (AF/NF/OAM)

NOTE: The NWDAF could also register a profile into a Data Collection Coordination Functionality (DCCF).

At step 2, the consumer (AF/NF/OAM) starts a subscription to the NWDAF by invoking an Nnwdaf_MLModelProvision_Subscribe service operation with consumer request. In addition to other parameters, the following parameters may also be included in the consumer request:
Time window for confirming response from NWDAF in preparation phase
Time window for intermediate results report from NWDAF
Time window for final outputs from NWDAF
Accuracy level could be achieved by the trained model
Information about consumer (e.g., Vendor ID, etc.)
Learning architecture, e.g., DML/FL framework, etc.
Output strategy for intermediate results reporting during the ML model training process, e.g., binary output strategy or gradient output strategy
Information about an initial model provider (e.g., the provider is internal or external to the consumer, or other vendors)
Initial ML model structure. In the consumer request, the ML model structure can be provided in any of the following formats:
If the subscription is terminated
   ML model ID
   ML model file address, e.g., URL
If the subscription is continuing.
   An indication of update based on the current ML model
Indication of online or offline learning. As used herein, online learning refers to real time ingest data during ML model training/learning process (i.e., dynamic dataset, the data may be generated and/or obtained in time during the ML model training/learning process). As used herein, offline learning refers to all the data being ingested at one time (i.e., static dataset, all the data are generated and obtained before the ML model training/learning process).
Data source, e.g., data type (e.g., the type of data used for inference and/or training), NF ID(s), information of data provider (e.g., Analytics Data Repository Function, or ADRF, etc.)
At step 3, the NWDAF judges the sharable artifacts based on the consumer type (e.g., internal or external consumer, the Vendor ID, etc.), Application scenarios, Analytics ID, information of initial model provider (e.g., NWDAF, or other vendors, etc.), and local policy, etc.
At steps 4, the NWDAF sends a response to the consumer (AF/NF/OAM) with information about sharable artifacts. If the sharable artifacts provided by the NWDAF are unmatched to the requirement from the consumer, the consumer (AF/NF/OAM) sends a request to terminate the DML/FL.

In particular, at step 4a, the NWDAF responds (Nnwdaf_MLModelProvision_Subscribe) to the consumer (AF/NF/OAM) with information about sharable artifacts (e.g., trained model, model meta data, model weights, etc.), and at step 4b, if unmatched, the consumer (AF/NF/OAM) sends a request to terminate the DML/FL (e.g., it sends an Nnwdaf_ML_Terminate request or an Nnwdaf_MLModelProvision_Unsubscribe request to the NWDAF). This would terminate the procedure.

At step 5 (if not terminated at step 4b), the NWDAF discovers one or more Client NWDAF(s) from the NRF (e.g., using Nnrf_NFDiscovery_Request).

At step 6, the NWDAF performs Client NWDAF Selection based on the requirements from the consumer (AF/NF/OAM) on DML/FL framework, input data source, etc.

At step 7, the NWDAF estimates the time for providing the required service (e.g., trained ML model, ML model meta data, ML model weights, etc.) to the consumer based on the currently selected Client NWDAF(s), and judges whether the preparation for DML/FL is ready.

NOTE: The time for completing ML model training is estimated if ML model provision is required.

At steps 8, the NWDAF responses to the consumer (AF/NF/OAM) with the information about preparation status and the estimated time for providing the required service (e.g., trained ML model, ML model meta data, ML model weights, etc.) within the time window for confirming response.

In particular, at step 8a, the NWDAF sends a response Nnwdaf_MLModelProvision_Subscribe) to the consumer (AF/NF/OAM), and at step 8b, if the estimated time does not match to the requirement from the consumer, the consumer (AF/NF/OAM) sends a request to terminate DML/FL (e.g., sends Nnwdaf_ML_Terminate request or an Nnwdaf_MLModelProvision_Unsubscribe request to the NWDAF).

### Procedure for Consumer Control of Training Execution Phase

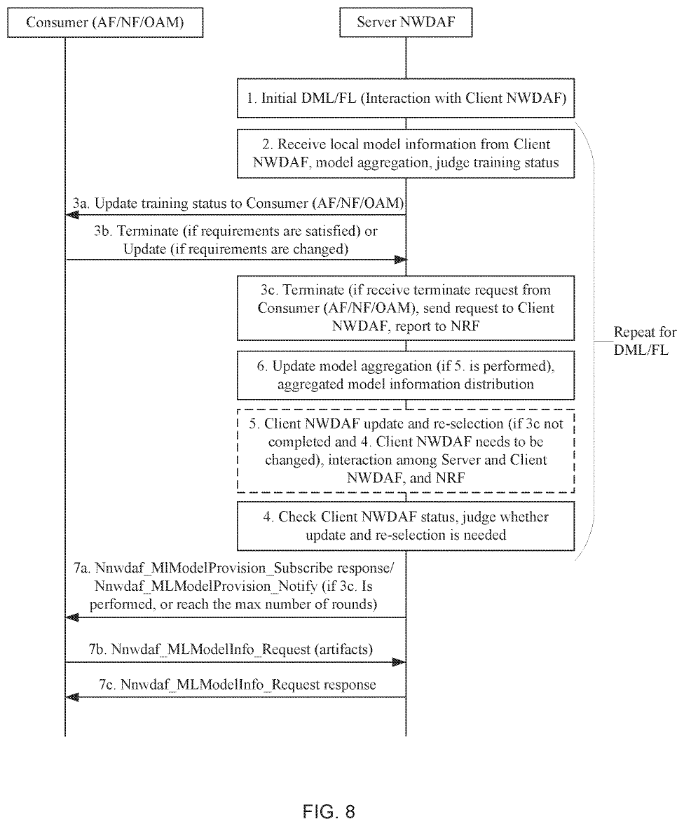

Interactions between the consumer (AF/NF/OAM) and the NWDAF during the training/learning processes are now considered. Procedures for the consumer (AF/NF/OAM) to control the ML model training execution phase in 5GC are discussed with reference to FIG. 8.

At step 1, the NWDAF (Server NWDAF) begins initial DML/FL parameter provisioning to all the selected Client NWDAF(s) with a requirement on a time window for local ML model reporting.

At step 2, the NWDAF (Server NWDAF) receives local ML model information from Client NWDAF(s), performs ML model aggregation on the received local ML models, and judges the training status (e.g., whether the current trained ML model could satisfy the accuracy requirement or not, whether it has converged or not, the remaining time to complete training, etc.).

At steps 3, the NWDAF (Server NWDAF) updates the training status (judged in step 2) to the consumer (AF/NF/OAM) periodically (one or multiple rounds of training), or dynamically (e.g., when a predetermined status required by the consumer is achieved (such as accuracy that can be achieved by the trained ML model), etc.), according to the prior communicated output strategy for intermediate results reporting. The consumer (AF/NF/OAM) decides whether to continue or not based on the training status. For example, the consumer (AF/NF/OAM) judges whether the time and accuracy requirements can be satisfied by the current trained ML model (or ML model parameters) provided by the NWDAF (Server NWDAF).

The corresponding processes are as follows:

At step 3a, the NWDAF (Server NWDAF) updates intermediate results, e.g., ML model training status (judged in step 2.), to the consumer (AF/NF/OAM). In the intermediate results report to the consumer (AF/NF/OAM), the following information may be included:
An indicator of the accuracy that could be achieved by the current trained ML model;
An indication of whether the training status is converged or not; and
The remaining time or effort required to complete training, or the remaining unfinished percentage of training tasks.

At step 3b, the consumer (AF/NF/OAM) sends a terminate request to the NWDAF (Server NWDAF) if its requirements can be satisfied based on the current ML model (or ML model parameters). For example. it may send an Nnwdaf_ML_Terminate request or an Nnwdaf_MLModelProvision_Unsubscribe request to the NWDAF (Server NWDAF), or send a request to update requirements if its requirements have changed.

At step 3c, if it receives a termination request from the consumer (AF/NF/OAM), the NWDAF (Server NWDAF) sends a terminate request to the Client NWDAF(s). For example, it may send an Nnwdaf_ML_Terminate request or an Nnwdaf_MLModelProvision_Unsubscribe request to Client NWDAF(s), and report the changes of status (Server and Client NWDAFs) to the NRF.

NOTE: The requirements on time, accuracy, and the like, at the consumer may change during the ML model training processes. The change may be caused, e.g., by interactions of the consumer with other service providers in the same time period.

At step 4, if it received update requirements, or if the ML model training is not complete (as judged in step 2), the NWDAF (Server NWDAF) checks the Client NWDAF(s)' status (capacity, available data, area, etc.), and judges whether Client NWDAF(s) update and re-selection is needed.

At step 5, if ML model training is not complete (as judged in step 2), and Client NWDAF update and re-selection is needed (as judged in step 4), the NWDAF (Server NWDAF) initiates the process for Client NWDAF(s) re-selection based on the update information (in step 4).

At step 6, if update and re-selection are performed (in step 5), the NWDAF (Server NWDAF) updates ML model aggregation, and sends the aggregated ML model information to the newly selected Client NWDAF(s).

NOTE: As indicated to the right in FIG. 8, steps 2-6 should be repeated until a relevant ML model training termination condition is satisfied (e.g., the maximum number of iterations, or the result of loss function is lower than a threshold, or termination request is received).

At step 7, the NWDAF (Server NWDAF) provides the required service to the consumer (AF/NF/OAM) within the time window for final outputs.

NOTE: The NWDAF (Server NWDAF) provides trained ML model (or ML model meta data, ML model weights, etc.) to the consumer (AF/NF/OAM) if ML model provision is required.

At step 7a, the NWDAF (Server NWDAF) provides the required trained ML model (or ML model meta data, ML model weights, etc.) to the consumer (AF/NF/OAM). For example, it may send an Nnwdaf_MLModelProvision_Subscribe response or Nnwdaf_MLModelProvision_Notify. The following information may be contained in the outputs:
The trained ML model (or ML model meta data, ML model weights, etc.)
An indication of the accuracy level that could be achieved by the trained ML model. The accuracy level could be provided, e.g., by the ML model meta data, or in a separate method, etc.
The learning architecture used for training the ML model, e.g., DML/FL, etc.
Whether the ML model is obtained by a training or a retraining process, and the corresponding initial ML model, for example
   If it is a training process, the initial ML model information is provided in step 2 of the consumer trigger and control of ML model provisioning process described above, e.g., by ML model ID or ML model file address (e.g., URL).
   If it is a retraining process, the initial ML model is the ML model used for starting the retraining; this ML model may be recorded during the training process.
The trained ML model is obtained by online or offline learning.
The actual data source used for training the ML model.

At step 7b, the consumer (AF/NF/OAM) sends a request to the NWDAF (Server NWDAF) for model information (e.g., Nnwdaf_MLModelInfo_Request) and/or triggers retraining.

At step 7c, the NWDAF (Server NWDAF) sends a response to the consumer (AF/NF/OAM) (e.g., Nnwdaf_MLModelInfo_Request response) with the required ML model information.

NOTE: As indicated to the left in FIG. 8, steps 2-7 could be repeated for retraining until the service required by the consumer (AF/NF/OAM) is satisfied.

### Methods and Apparatuses

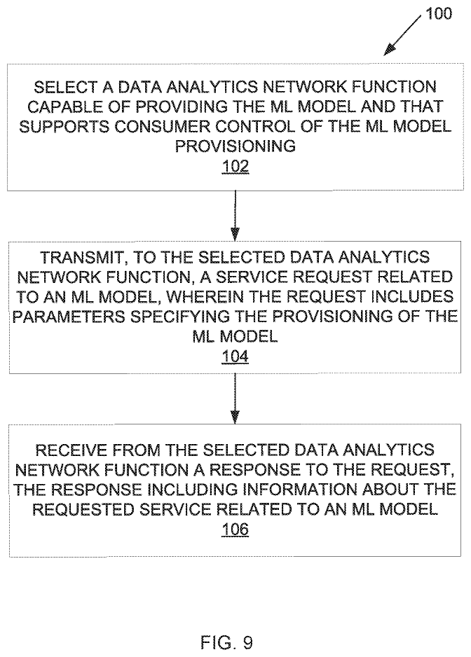

FIG. 9 depicts a method 100, in accordance with particular aspects, controlling the provision of an ML model, by a consumer of the ML model, in a wireless communication network. A data analytics network function capable of providing the ML model and that supports consumer control of the ML model provisioning is selected (block 102). A service request related to an ML model is transmitted to the selected data analytics network function, wherein the request includes parameters specifying the provisioning of the ML model (block 104). A response to the request is received from the selected data analytics network function, the response including information about the requested service related to an ML model (block 106).

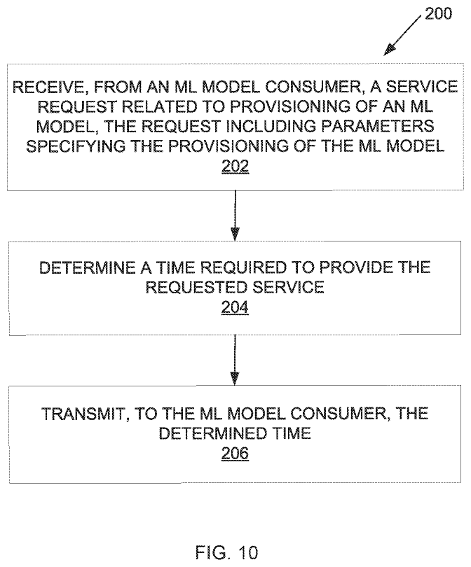

FIG. 10 depicts a method 200, in accordance with other particular aspects, of providing a Machine Learning (ML) model according to specifications of a consumer of the ML model, by a data analytics network function operative in a wireless communication network. A service request related to provisioning of an ML model is received from an ML model consumer, the request including parameters specifying the provisioning of the ML model (block 202). A time required to provide the requested service is determined (block 204). The determined time is transmitted to the ML model consumer (block 206).

Note that apparatuses described herein may perform the methods 100, 200 herein and any other processing by implementing any functional means, modules, units, or circuitry. In one aspect, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several aspects. In aspects that employ memory, the memory stores program code that, when executed by the one or more processors, carries out the techniques described herein.

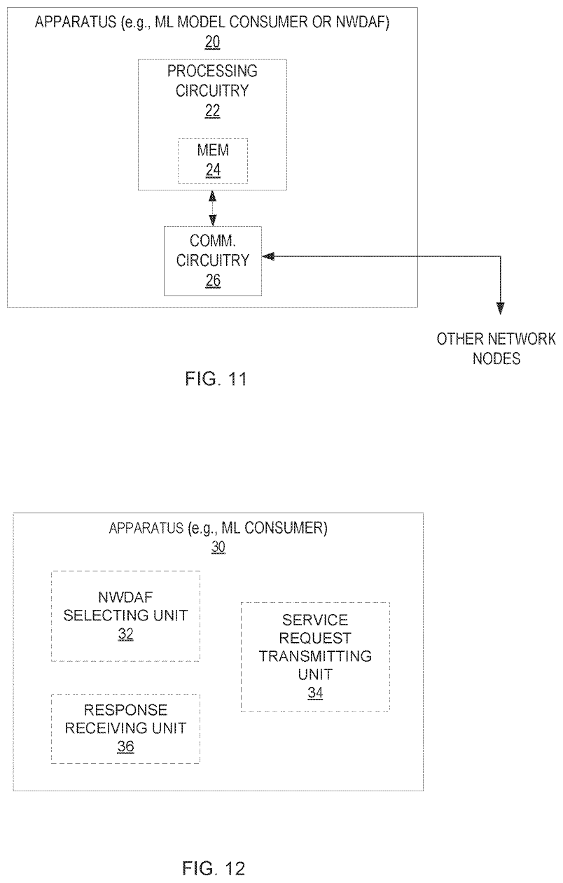

FIG. 11 for example illustrates a hardware block diagram of an apparatus 20 as implemented in accordance with one or more aspects of the present disclosure. In one aspect the apparatus 20 may be a consumer of a ML model, such as an Application Function (AF), Network Function (NF), or Operations, Administration and Maintenance (OAM) entity. In another aspect the apparatus 20 may be producer of ML models, such as a Network Data Analytics Function (NWDAF) having at least one Model Training Logical Function (MTLF). As shown, the apparatus 20 includes processing circuitry 22 and communication circuitry 26. The communication circuitry 26 is configured to transmit and/or receive information to and/or from one or more network nodes or entities outside the network, e.g., via any communication technology. The processing circuitry 22 is configured to perform processing described above, such as by executing instructions stored in memory 24, which may be internal, as shown, or may be external to the processing circuitry 22. The processing circuitry 22 in this regard may implement certain functional means, units, or modules.

FIG. 12 illustrates a functional block diagram of an ML model consumer apparatus 30 in or connected to a wireless network, according to still other aspects. As shown, the ML model consumer apparatus 30 implements various functional means, units, or modules, e.g., via the processing circuitry 22 in FIG. 11 and/or via software code. These functional means, units, or modules, e.g., for implementing the method 100 herein, include for instance: NWDAF selecting unit 32, service request transmitting unit 34, and response receiving unit 36.

NWDAF selecting unit 32 is configured to select a data analytics network function capable of providing the ML model and that supports consumer control of the ML model provisioning. Service request transmitting unit 34 is configured to transmit, to the selected data analytics network function, a service request related to an ML model, wherein the request includes parameters specifying the provisioning of the ML model. Response receiving unit 36 is configured to receive from the selected data analytics network function a response to the request, the response including information about the requested service related to an ML model.

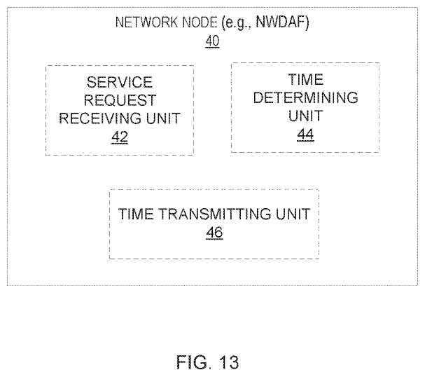

FIG. 13 illustrates a functional block diagram of a network node 40 implementing an NWDAF in a wireless network, according to still other aspects. As shown, the NWDAF network node 40 implements various functional means, units, or modules, e.g., via the processing circuitry 22 in FIG. 11 and/or via software code. These functional means, units, or modules, e.g., for implementing the method 200 herein, include for instance: service request receiving unit 42, time determining unit 44, time transmitting unit 46.

Service request receiving unit 42 is configured to receive, from an ML model consumer, a service request related to provisioning of an ML model, the request including parameters specifying the provisioning of the ML model. Time determining unit 44 is configured to determine a time required to provide the requested service. Time transmitting unit 46 is configured to transmit, to the ML model consumer, the determined time.

Those skilled in the art will also appreciate that aspects herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Aspects further include a carrier containing such a computer program. This carrier may comprise one of an electronic signal, optical signal, radio signal, or computer readable storage medium.

In this regard, aspects herein also include a computer program product stored on a non-transitory computer readable (storage or recording) medium and comprising instructions that, when executed by a processor of an apparatus, cause the apparatus to perform as described above.

Aspects further include a computer program product comprising program code portions for performing the steps of any of the aspects herein when the computer program product is executed by a computing device. This computer program product may be stored on a computer readable recording medium.

Aspects of the present disclosure present numerous advantages over the prior art. In prior art solutions, such as the one in 3GPP TR 23.700-91 for Federated Learning (FL) among multiple NWDAF instances, neither the model provisioning process nor the training/learning processes can be controlled by the ML model consumer. Aspects disclosed and claimed herein provide for ML model consumer to control both the provisioning of an ML model, and its training execution process. This allows the ML model consumer to specify numerous parameters, such as the learning architecture (e.g., DML/FL); the type of data used for training (e.g., online or offline); time windows for critical aspects of the ML model provisioning and training (e.g., for confirming response from NWDAF in preparation phase, for intermediate results reporting from NWDAF, and for final outputs from NWDAF); an accuracy level the trained ML model can achieve; an output strategy for intermediate results reported during training; information about an initial ML model to be used; and the like. Furthermore, during training execution, the ML model consumer can specify that the NWDAF report various parameters related to the ML model and its training process, and the ML model can terminate the ML model provisioning and/or training process at several points, if the reported parameters do not match requirements of the ML model consumer. Aspects of the present disclosure thus support and enable use cases in wireless communication networks that are heretofore impossible to implement.

For ease of explication and to place the disclosure in a real-world context, aspects of the present disclosure are presented herein in the context of 3GPP 5G core networks (5GC). However, this is not a limitation of aspects of the present disclosure. Methods and signaling disclosed herein may be advantageously employed in any wireless communication network in which ML model consumers (e.g., AF, NF, or OAM) may need or desire to specify aspects of the ML model provisioning and/or training execution.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the aspects disclosed herein may be applied to any other aspect, wherever appropriate. Likewise, any advantage of any of the aspects may apply to any other aspects, and vice versa. Other objectives, features, and advantages of the enclosed aspects will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein. As used herein, the term “configured to” means set up, organized, adapted, or arranged to operate in a particular way; the term is synonymous with “designed to.” As used herein, the term “substantially” means nearly or essentially, but not necessarily completely; the term encompasses and accounts for mechanical or component value tolerances, measurement error, random variation, and similar sources of imprecision.

Some of the aspects contemplated herein are described more fully with reference to the accompanying drawings. Other aspects, however, are contained within the scope of the subject matter disclosed herein. The disclosed subject matter should not be construed as limited to only the aspects set forth herein; rather, these aspects are provided by way of example to convey the scope of the subject matter to those skilled in the art.

1-54. (canceled)

55. A method of controlling the provision of a Machine Learning (ML) model, by a consumer of the ML model, in a wireless communication network, comprising:
selecting a data analytics network function capable of providing the ML model and that supports consumer control of the ML model provisioning;
transmitting, to the selected data analytics network function, a service request related to an ML model, wherein the request includes parameters specifying the provisioning of the ML model; and
receiving from the selected data analytics network function a response to the request, the response including information about the ML model preparation status and an estimated time for providing the requested service related to the ML model.

56. The method of claim 55, further comprising, prior to selecting a data analytics network function:
discovering, in the network, one or more data analytics network functions capable of providing the ML model and that supports consumer control of the ML model provisioning; and
selecting the data analytics network function from among those discovered.

57. The method of claim 55, further comprising, after transmitting the request and prior to receiving the response:
receiving from the selected data analytics network function information about sharable artifacts related to the ML model;
in response to the sharable artifacts not matching predetermined requirements of the consumer, terminating the request; and
in response to the sharable artifacts matching predetermined requirements of the consumer, waiting for the response from the selected data analytics network function.

58. The method of claim 57, wherein the sharable artifacts comprise one or more of whether the consumer is internal or external to the network, application scenarios, analytics identification, identification of an initial model provider, and local policy.

59. The method of claim 56, wherein discovering one or more data analytics network functions that supports consumer control of the ML model provisioning comprises sending a discovery request to a network repository function wherein the discovery request includes parameters specifying characteristics of the data analytics network function, the ML model, or the ML model provisioning.

60. The method of claim 59, wherein the parameters specifying characteristics of the data analytics network function, the ML model, or the ML model provisioning comprise one or more of a capability of the data analytics network function to support consumer control of ML model training, supported ML model learning architectures, a capability of the data analytics network function to output intermediate results during ML model training, and whether an initial ML model structure is may be provided by the consumer.

61. The method of claim 55, wherein the parameters specifying the the provisioning of the ML model comprise one or more of a time window for intermediate or final outputs, an accuracy level that can be achieved by the ML model, a learning architecture, output strategy for intermediate results during ML model training, information about an initial ML model provider, an initial ML model structure, an indication whether the learning is online or offline, and information about data source(s).

62. The method of claim 55, further comprising, after receiving the response from the selected data analytics network function, receiving, from the selected data analytics network function, a status update regarding training of the ML model, wherein the status update comprises one or more of an accuracy that can be achieved by the current trained ML model, an indication whether training of the ML model has converged, and an indication of the time or percentage of task to complete training the ML model.

63. An Machine Learning (ML) model consumer apparatus operative in or connected to a wireless communication network, comprising:
communication circuitry; and
processing circuitry operatively connected to the communication circuitry, the processing circuitry configured to
transmit, to a selected data analytics network function capable of providing the ML model and that supports consumer control of the ML model provisioning, a service request related to an ML model, wherein the request includes parameters specifying the provisioning of the ML model; and
receive from the selected data analytics network function a response to the request, the response including information about the ML model preparation status and an estimated time for providing the requested service related to the ML model.

64. The consumer apparatus of claim 63, wherein the processing circuitry is further configured to, prior to selecting the data analytics network function:
discover, in the network, one or more data analytics network functions capable of providing the ML model and that supports consumer control of the ML model provisioning; and
select a data analytics network function from among those discovered.

65. The consumer apparatus of claim 63, wherein the processing circuitry is further configured to, after transmitting the request and prior to receiving the response:
receive from the selected data analytics network function information about sharable artifacts related to the ML model;
in response to the sharable artifacts not matching predetermined requirements of the consumer, terminate the request; and
in response to the sharable artifacts matching predetermined requirements of the consumer, wait for the response from the selected data analytics network function.

66. The consumer apparatus of claim 63, wherein the processing circuitry is configured to discover one or more data analytics network functions that supports consumer control of the ML model provisioning by sending a discovery request to a network repository function wherein the discovery request includes parameters specifying characteristics of the data analytics network function, the ML model, or the ML model provisioning.

67. The consumer apparatus of claim 66, wherein the parameters specifying characteristics of the data analytics network function, the ML model, or the ML model provisioning comprise one or more of a capability of the data analytics network function to support consumer control of ML model training, supported ML model learning architectures, a capability of the data analytics network function to output intermediate results during ML model training, and whether an initial ML model structure may be provided by the consumer.

68. The consumer apparatus of claim 63, wherein the parameters specifying the provisioning of the ML model comprise one or more of a time window for intermediate or final outputs, an accuracy level that can be achieved by the ML model, a learning architecture, output strategy for intermediate results during ML model training, information about an initial ML model provider, an initial ML model structure, an indication whether the learning is online or offline, and information about data source(s).

69. The consumer apparatus of claim 63, wherein the processing circuitry is further configured to, after receiving the response from the selected data analytics network function, receive, from the selected data analytics network function, a status update regarding training of the ML model, wherein the status update comprises one or more of an accuracy that can be achieved by the current trained ML model, an indication whether training of the ML model has converged, and an indication of the time or percentage of task to complete training the ML model.

70. A method, by a data analytics network function operative in a wireless communication network, of providing a Machine Learning (ML) model according to specifications of a consumer of the ML model, comprising:
receiving, from an ML model consumer, a service request related to provisioning of an ML model, the request including parameters specifying the provisioning of the ML model;
determining a time required to provide the requested service;
transmitting, to the ML model consumer, the determined time.

71. The method of claim 70, further comprising, prior to receiving the service request from the ML model consumer, registering a profile with a network registry function, the profile comprising one or more of a capability of supporting consumer control of ML model provisioning, an indication of supported learning architectures, a capability of providing intermediate results, and a capability of running an initial ML model provided by a consumer.

72. The method of claim 70, wherein parameters specifying the provisioning of the ML model comprise one or more of a time window for intermediate or final outputs, an accuracy level that can be achieved by the ML model, a learning architecture, output strategy for intermediate results during ML model training, information about an initial ML model provider, an initial ML model structure, an indication whether the learning is online or offline, and information about data source(s).

73. The method of claim 70, wherein the parameters specifying the requested service related to an ML model comprise a learning architecture being a Distributed Machine Learning/Federated Learning (DML/FL) architecture, and further comprising:
discovering one or more client data analytics network function to utilize in DML/FL ML model training;
selecting one or more discovered client data analytics network functions; and
provisioning the selected client data analytics network functions with one of initial DML/FL parameters and requirement on time window for local model reporting.

74. The method of claim 73, further comprising:
receiving local model information from client data analytics network functions;
performing model aggregation on the received local model information;
judging training status; and
updating the ML model consumer on ML model training status.

75. A network node implementing a data analytics network function in a wireless communication network, comprising:
communication circuitry; and
processing circuitry operatively connected to the communication circuitry, the processing circuitry configured to
receive, from a Machine Learning (ML) model consumer, a service request related to provisioning of an ML model, the request including parameters specifying the provisioning of the ML model;
determine a time required to provide the requested service;
transmit, to the ML model consumer, the determined time.

76. The network node of claim 75, wherein the processing circuitry is further configured to, prior to receive the service request from the ML model consumer, register a profile with a network registry function, the profile comprising one or more of a capability of supporting consumer control of ML model provisioning, an indication of supported learning architectures, a capability of providing intermediate results, and a capability of running an initial ML model provided by a consumer.

77. The network node of claim 75, wherein parameters specifying the provisioning of the ML model comprise one or more of a time window for intermediate or final outputs, an accuracy level that can be achieved by the ML model, a learning architecture, output strategy for intermediate results during ML model training, information about an initial ML model provider, an initial ML model structure, an indication whether the learning is online or offline, and information about data source(s).

78. The network node of claim 75, wherein the parameters specifying the requested service related to an ML model comprise one or more of a time window for intermediate or final outputs, an accuracy level that can be achieved by the ML model, a learning architecture, output strategy for intermediate results during ML model training, information about an initial ML model provider, an initial ML model structure, an indication whether the learning is online or offline, and information about data source(s).

79. The network node of claim 78, wherein the parameters specifying the requested service related to an ML model comprise a learning architecture being a Distributed Machine Learning/Federated Learning, DML/FL, architecture, and wherein the processing circuitry is further configured to:
discover one or more client data analytics network function to utilize in DML/FL ML model training;
select one or more discovered client data analytics network functions; and
provisioning the selected client data analytics network functions with one of initial DML/FL parameters and requirement on time window for local model reporting.

80. The network node of claim 78, wherein the processing circuitry is further configured to:
receive local model information from client data analytics network functions;
perform model aggregation on the received local model information;
judge training status; and
update the ML model consumer on ML model training status.
